(19) United States
(12) Patent Application Publication
(10) Pub. No.: US 2025/0023392 A1
(43) Pub. Date: Jan. 16, 2025

(54) WIRELESS POWER RECEIVER DEVICE

(71) Applicant: Murata Manufacturing Co., Ltd., Kyoto-fu (JP)

(72) Inventors: Tatsuya HOSOTANI, Nagaokakyo-shi (JP); Kiyokazu YAMADA, Nagaokakyo-shi (JP)

(73) Assignee: Murata Manufacturing Co., Ltd., Kyoto-fu (JP)

(21) Appl. No.: 18/896,317

(22) Filed: Sep. 25, 2024

Related U.S. Application Data
(63) Continuation of application No. PCT/JP2023/015535, filed on Apr. 19, 2023.

(30) Foreign Application Priority Data
Apr. 21, 2022 (JP) 2022-069836

(51) Int. Cl. H02J 50/12; H02J 50/00; H02J 50/70; H02J 50/80; H04R 1/10

(52) U.S. Cl. CPC H02J 50/12; H02J 50/005; H02J 50/70; H02J 50/80; H04R 1/1025; H04R 2225/31; H04R 2225/51

(57) ABSTRACT

A wireless power receiver device includes a receiver coil, an electronic circuit, a load circuit, a magnetic sheet, and a housing. The magnetic sheet is disposed with respect to the receiver coil. The housing, in which the receiver coil, the electronic circuit, the load circuit, and the magnetic sheet are disposed, has a three-dimensional complex structure body. The receiver coil has a shape having multiple curvatures and bending three-dimensionally along the outer surface or the inner surface of the three-dimensionally structured housing. The magnetic sheet is disposed in the inner space of the receiver coil three-dimensionally at such a position that the magnetic sheet surrounds the electronic circuit and the load circuit, so as to form the magnetic path of the main magnetic flux, which is linked with the receiver coil, with respect to a magnetic field from the outside of the three-dimensionally structured housing.

### CROSS-REFERENCE TO RELATED APPLICATIONS

This application claims benefit of priority to International Patent Application No. PCT/JP2023/015535, filed Apr. 19, 2023, and to Japanese Patent Application No. 2022-069836, filed Apr. 21, 2022, the entire contents of each are incorporated herein by reference.

### BACKGROUND

### Technical Field

The present disclosure relates to a wireless power receiver device having a three-dimensional complex structure body.

### BACKGROUND ART

Recently, there has been a demand for wireless power reception or wireless charging for portable devices such as a hearing aid, because wireless power reception or wireless charging has high convenience with no need to replace batteries like single-use primary batteries.

Japanese Unexamined Patent Application Publication No. 2014-161177 describes a portable device equipped with a wireless power reception function or a wireless charging function. In the portable device described in Japanese Unexamined Patent Application Publication No. 2014-161177, a loop coil for power reception is formed along the outer wall of the housing.

### SUMMARY

However, when a portable device has a three-dimensional complex structure body like a hearing aid, for example, if a circular receiver coil is used, it is difficult to obtain sufficient received power because the receiver coil is made small due to limitation in shape of the three-dimensional structure body. In addition, since the structure body is complex, the space occupied by the receiver coil is large, resulting in no space for placement of an electronic circuit substrate.

In contrast, even if a three-dimensional receiver coil, which bends along the outer surface or the inner surface of the three-dimensional complex structure body, is formed, the main magnetic flux for wireless power transmission may fail to be linked with the receiver coil, or magnetic fluxes, whose vectors are opposite to each other, may cancel each other. Thus, it is difficult to achieve a wireless power receiver with high efficiency.

In addition, if the energy of an external magnetic field is made high to obtain sufficient received power while these issues hold, unnecessary electromagnetic noise, which occurs in an electronic circuit, may increase, resulting in a malfunction of the electronic circuit or damage to the electronic component due to excess stress on the electronic component.

Accordingly, the present disclosure provides a wireless power receiver device which, although having a three-dimensional complex structure body, achieves both a reduction in size and high efficiency of power reception, and which suppresses occurrence of a malfunction of an electronic circuit and damage to the electronic circuit.

The disclosure provides a wireless power receiver device including a receiver loop coil, an electronic circuit substrate, a load circuit, a magnetic sheet, and a housing. The electronic circuit substrate includes a power receiving circuit which is electrically connected to the receiver loop coil. The load circuit performs an electrical operation by using received power obtained from the power receiving circuit. The magnetic sheet is disposed with respect to the receiver loop coil. The housing includes the receiver loop coil, the electronic circuit substrate, the load circuit, and the magnetic sheet which are disposed therein, and has a three-dimensional complex structure.

The electronic circuit substrate and the load circuit include electronic components. The receiver loop coil has a shape having a plurality of curvatures and bending three-dimensionally along the outer surface or the inner surface of the three-dimensionally structured housing. The magnetic sheet is disposed in the inner space of the receiver loop coil three-dimensionally at such a position that the magnetic sheet surrounds the electronic circuit substrate and the load circuit, so as to form the magnetic path of the main magnetic flux, which is linked with the receiver loop coil, with respect to a magnetic field from an outside of the three-dimensionally structured housing. For the receiver loop coil, flux linkage is increased to obtain a larger received power at the power receiving circuit, and, for the electronic circuit substrate, linkage of the main magnetic flux is suppressed to reduce occurrence of unnecessary electromagnetic noise in the electronic circuit substrate.

According to the configuration, even though the housing has a three-dimensional complex structure, while a reduction in size of the shape of the receiver loop coil is decreased, the magnetic sheet may cause the flux linkage through the receiver coil to increase, and the magnetic sheet may cause reduction of linkage of the main magnetic flux with the electronic circuit substrate.

According to the disclosure, even with a three-dimensional complex structure body, both a reduction in size and high efficiency of power reception are achieved. In addition, while received power is increased, occurrence of unnecessary electromagnetic noise in an electronic circuit substrate and a load circuit may be reduced, suppressing occurrence of a malfunction of an electronic circuit and damage to an electronic circuit.

### BRIEF DESCRIPTION OF THE DRAWINGS

FIG. 1 is a circuit diagram of a wireless power receiver device according to an embodiment of the present disclosure;

FIG. 2A is an external perspective view of a wireless power receiver device according to a first embodiment; and FIG. 2B is a perspective view of the state in which the housing in FIG. 2A is seen through;

FIGS. 3A, 3B, 3C, and 3D are views of the four sides of a wireless power receiver device according to the first embodiment;

FIG. 4A is a perspective view of the case in which a wireless power receiver device is placed on or close to a transmitter stand for power transmission; and FIG. 4B is a view of the state as seen in the y-axis direction;

FIG. 5A is an external perspective view of a wireless power receiver device according to a second embodiment; and FIG. 5B is a perspective view of the state in which the housing in FIG. 5A is seen through;

FIGS. 6A, 6B, 6C, and 6D are views of the four sides of a wireless power receiver device according to the second embodiment;

FIG. 7A is a perspective view of the case in which a wireless power receiver device is placed on or close to a transmitter stand for power transmission; and FIG. 7B is a view of the state as seen in the y-axis direction;

FIG. 8A is an external perspective view of a wireless power receiver device according to a third embodiment; and FIG. 8B is a perspective view of the state in which the housing in FIG. 8A is seen through;

FIGS. 9A, 9B, 9C, and 9D are views of the four sides of a wireless power receiver device according to the third embodiment; and

FIG. 10A is a perspective view of the case in which a wireless power receiver device is placed on or close to a transmitter stand for power transmission; and FIG. 10B is a view of the state as seen in the z-axis direction.

### DETAILED DESCRIPTION

### First Embodiment

A wireless power receiver device according to a first embodiment of the present disclosure will be described by referring to figures.

### (The Circuit Configuration of a Wireless Power Receiver Device 10)

### (Connection Configuration and Brief Overview of Operations)

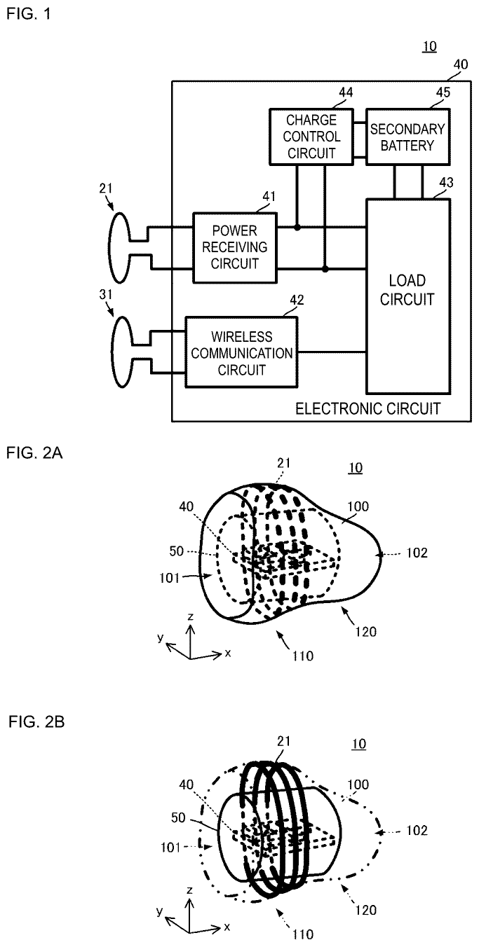

FIG. 1 is a circuit diagram of a wireless power receiver device according to an embodiment of the present disclosure. As illustrated in FIG. 1, a wireless power receiver device 10 includes a receiver coil 21, a communication antenna 31, and an electronic circuit 40. The electronic circuit 40 includes a power receiving circuit 41, a wireless communication circuit 42, a load circuit 43, a charge control circuit 44, and a secondary battery 45. The communication antenna 31 and the wireless communication circuit 42 may be omitted.

The receiver coil 21 is connected to the input terminals of the power receiving circuit 41. The receiver coil 21 and a capacitor or the like of the power receiving circuit 41 form a receiver resonant circuit. The resonant frequency of the receiver resonant circuit is set to the same as the frequency of the alternating magnetic field to which the receiver coil 21 is coupled (the same as the drive frequency of a power transmitter device which generates the alternating magnetic field). Such setting of the resonant frequency causes an electromagnetic resonance field between the receiver coil 21 and the transmitter coil of the power transmitter device to be formed, enabling highly efficient power reception. Preferably, the frequency of the alternating magnetic field is, for example, 6.78 MHz or 13.56 MHz in the ISM band.

The output terminals of the power receiving circuit 41 are connected to the input terminals of the load circuit 43 and the charge control circuit 44. The power receiving circuit 41 includes a resonance control circuit and a rectifier circuit. The resonance control circuit of the power receiving circuit 41 adjusts the power-reception resonant frequency. The rectifier circuit rectifies the output current from the receiver coil 21, and outputs a direct current and a direct current voltage to the load circuit 43 and the charge control circuit 44.

The output terminals of the charge control circuit 44 are connected to the secondary battery 45. The charge control circuit 44 receives output from the power receiving circuit 41, and charges the secondary battery 45.

The secondary battery 45 is, for example, a thin battery. This facilitates accommodation of the secondary battery 45 in a housing 100 described below, enabling the size of the housing 100 not to be made large. The secondary battery 45, which is connected to the load circuit 43, enables power supply to the load circuit 43. The secondary battery 45 corresponds to a “power storage device” in the present disclosure.

The load circuit 43 is driven by using direct current power from the power receiving circuit 41 or the secondary battery 45. The load circuit 43 is, for example, a circuit which performs the functions of a device implemented by the wireless power receiver device 10. For example, when the wireless power receiver device 10 is a hearing aid, the load circuit 43 is constituted, for example, by a microphone and an amplifier circuit for an audio signal.

The wireless communication circuit 42 performs wireless communication with an external device (for example, the power transmitter device) through the communication antenna 31. The frequency of the wireless communication may be the same as or different from the power reception frequency (the frequency of the alternating magnetic field). When the frequency of the wireless communication is the same as the power reception frequency, the communication antenna 31 may be omitted and the receiver coil 21 may be used also as the communication antenna.

### (The Structure of the Wireless Power Receiver Device 10)

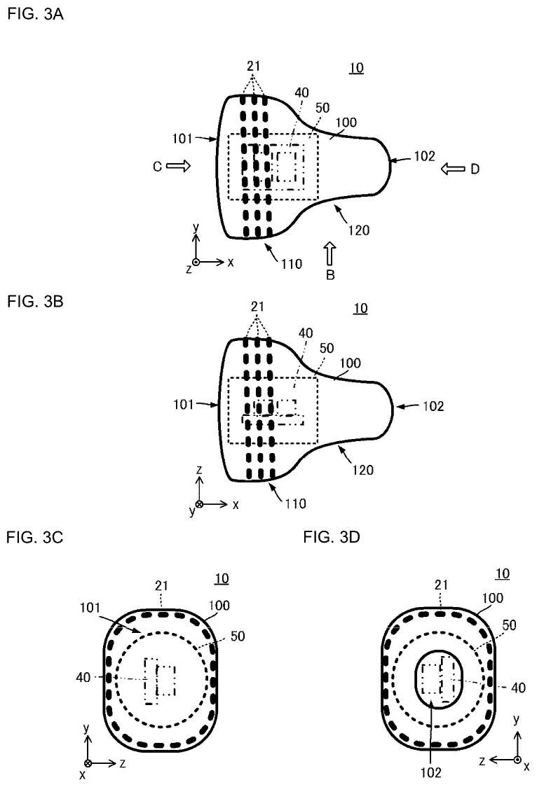

FIG. 2A is an external perspective view of a wireless power receiver device according to the first embodiment. FIG. 2B is a perspective view of the state in which the housing in FIG. 2A is seen through. FIGS. 3A, 3B, 3C, and 3D are views of the four sides of the wireless power receiver device according to the first embodiment. FIG. 3B is a view of FIG. 3A as seen in B direction; FIG. 3C is a view of FIG. 3A as seen in C direction; FIG. 3D is a view of FIG. 3A as seen in D direction. In the description below, to make description about the shape easy to understand, the x-axis direction, the y-axis direction, and the z-axis direction are used in the description. The x axis, the y axis, and the z axis simply mean three axes orthogonal to one another.

As illustrated in FIGS. 2A and 2B and FIGS. 3A, 3B, 3C, and 3D, the wireless power receiver device 10 includes the housing 100. The housing 100 has a shape that matches the shape of a concha. In the description below, the shape will be described by focusing on points related to the points of the disclosure.

The housing 100 includes a first portion 110 and a second portion 120. The outer shape of the first portion 110 is larger than that of the second portion 120. The first portion 110 and the second portion 120 has a shape having round corners of a cylindrical shape.

The first portion 110 and the second portion 120 are connected to each other side by side in the x-axis direction. The connection portion between the first portion 110 and the second portion 120 is formed as a curved surface.

Thus, the housing 100 is a three-dimensional complex structure body including multiple curved surfaces, each of which has a different curvature.

In the housing 100 which is such a three-dimensional complex structure body, the circuit devices, which implement the circuit configuration described above, are included.

The receiver coil 21 is a loop coil obtained by winding a linear conductor a predetermined number of times. The receiver coil 21 is disposed inside the inner surface of the first portion 110 of the housing 100. Alternatively, the receiver coil 21 may be disposed on the outer surface of the first portion 110. That is, the receiver coil 21 has a shape which has multiple curvatures and which bends three-dimensionally along the outer surface or the inner surface of the three-dimensionally structured housing 100.

More specifically, the receiver coil 21 is disposed along a circumferential plane, which extends in the x-axis direction, inside the inner surface of the first portion 110. In other words, the receiver coil 21 is disposed so as to extend circularly when the housing 100 is viewed in the x-axis direction.

The receiver coil 21 is disposed at the first portion 110, achieving a larger outer shape and a larger central opening of the receiver coil 21 compared with the case in which the receiver coil 21 is disposed at the second portion 120.

The electronic circuit 40 is formed by using an electronic circuit substrate. The electronic circuit substrate includes multiple electronic components and a base substrate on or in which the electronic components are mounted.

The base substrate is constituted by a multilayer body of insulating resin layers and conductor layers. The base substrate may be a solid substrate, or may be a flexible substrate.

The electronic components are circuit devices for forming the power receiving circuit 41, the wireless communication circuit 42, the load circuit 43, the charge control circuit 44, and the secondary battery 45, respectively.

These electronic components, which are mounted on or in the base substrate, form the electronic circuit 40. The electronic circuit 40 is disposed approximately at the center of the interior of the housing 100.

A magnetic sheet 50 has a cylindrical shape. The magnetic sheet 50 is disposed so as to contain and cover the electronic circuit 40 (electronic circuit substrate). In other words, the magnetic sheet 50 is disposed between the receiver coil 21 and the electronic circuit 40 (electronic circuit substrate). At that time, the magnetic sheet 50 is disposed so that its cylindrical surface faces the receiver coil 21. Preferably, in the interior of the housing 100, the cylindrical surface portion of the magnetic sheet 50 (the portion facing the receiver coil 21) is disposed as close as possible to the receiver coil 21.

In this configuration, the magnetic sheet 50 is disposed in the inner space of the receiver coil 21 three-dimensionally at such a position that the magnetic sheet 50 surrounds the electronic circuit 40 (electronic circuit substrate), so as to form the magnetic path of the main magnetic flux, which is linked with the receiver coil 21, with respect to a magnetic field from the outside of the three-dimensionally structured housing 100.

The receiver coil 21 and the electronic circuit 40 are appropriately connected to each other (not illustrated). The connection portion is connected, for example, through a slit formed through the magnetic sheet 50.

For example, the receiver coil 21 is formed on an insulating flexible sheet. The flexible sheet is connected to the base substrate on or in which the electronic circuit 40 is formed. Alternatively, the flexible sheet and the base substrate may be integrally formed.

When the base substrate is a flexible substrate, the base substrate is formed so as to have a first area, in which the receiver coil 21 is formed, and a second area, in which the electronic components are mounted. At that time, the number of laminated layers constituted by resin layers and conductor layers in the first area is preferably greater than that in the second area. This enables the number of windings of the receiver coil 21 to be greater, achieving further improvement of the power reception efficiency.

### (Placement Form on a Transmitter Stand 190 and Power Reception Form)

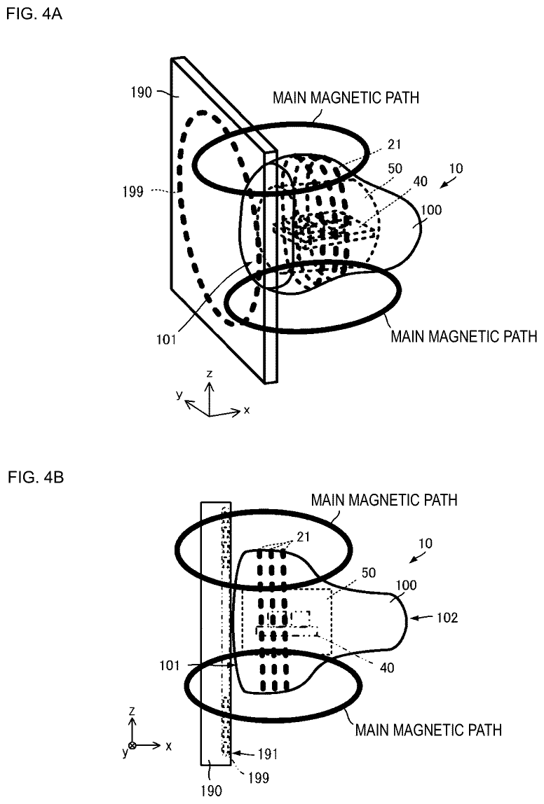

FIG. 4A is a perspective view of the case in which a wireless power receiver device is placed on or close to a transmitter stand for power transmission. FIG. 4B is a view of the state as seen in the y-axis direction.

As illustrated in FIGS. 4A and 4B, the wireless power receiver device 10, which is placed on or close to a transmitter stand 190, receives power transmission. The transmitter stand 190 has a transmitter surface 191. A transmitter coil 199 is, for example, a planar spiral coil. The transmitter coil 199 is disposed near and parallel to the transmitter surface 191. Thus, near the transmitter surface 191, a magnetic flux, which is generated due to a current flowing through the transmitter coil 199, goes in the direction approximately orthogonal to the transmitter surface 191.

As illustrated in FIGS. 4A and 4B, the wireless power receiver device 10 is placed on or close to the transmitter surface 191 of the transmitter stand 190 so that the first portion 110's surface, which is on the side opposite the side on which the first portion 110 is connected to the second portion 120, is close to (or abuts with) the transmitter surface 191.

Thus, the receiver coil 21 and its round plane are parallel to the planar plane of the transmitter coil 199. Therefore, the receiver coil 21 is coupled to the magnetic flux, which is generated due to a current through the transmitter coil 199, with a high degree of coupling. Thus, a large received current is output from the receiver coil 21.

Further, the receiver coil 21 is formed in a large area with respect to the shape of the housing 100. Therefore, a further larger output current from the receiver coil 21 may be obtained.

According to the configuration described above, as illustrated in FIGS. 4A and 4B, the magnetic sheet 50 causes the magnetic path (main magnetic path) of the main magnetic flux to be formed at a close position on the inner side of the receiver coil 21. This enables an increase of the flux linkage through the receiver coil 21, achieving output of a further larger received current.

Thus, even with a small housing 100 having a three-dimensional complex structure, the wireless power receiver device 10 achieves a large received power and high efficiency of power reception.

In addition, as described above, the magnetic sheet 50 surrounds the electronic circuit 40, suppressing occurrence of the state in which the main magnetic flux is linked with the electronic circuit 40. Thus, the wireless power receiver device 10 achieves reduction of occurrence of unnecessary electromagnetic noise in the electronic circuit 40.

### Second Embodiment

A wireless power receiver device according to a second embodiment of the present disclosure will be described by referring to figures.

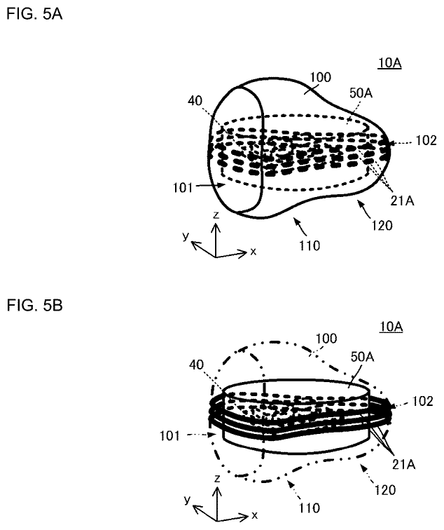

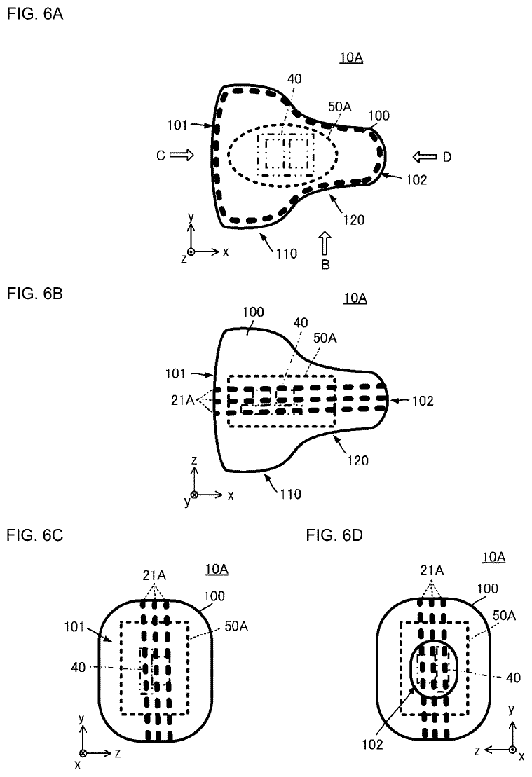

FIG. 5A is an external perspective view of a wireless power receiver device according to the second embodiment. FIG. 5B is a perspective view of the state in which the housing in FIG. 5A is seen through. FIGS. 6A, 6B, 6C, and 6D are views of the four sides of a wireless power receiver device according to the second embodiment. FIG. 6B is a view of FIG. 6A as seen in B direction; FIG. 6C is a view of FIG. 6A as seen in C direction; FIG. 6D is a view of FIG. 6A as seen in D direction.

A wireless power receiver device 10A according to the second embodiment is different from the wireless power receiver device 10 according to the first embodiment in a receiver coil 21A and a magnetic sheet 50A. The other configuration of the wireless power receiver device 10A is substantially the same as that of the wireless power receiver device 10, and substantially the same points will not be described.

The receiver coil 21A is a loop coil having a shape obtained by winding a linear conductor a predetermined number of times. The receiver coil 21A is disposed across the inner surfaces of the first portion 110 and the second portion 120 of the housing 100. Alternatively, the receiver coil 21A may be disposed on the outer surfaces of the first portion 110 and the second portion 120.

More specifically, the receiver coil 21A is disposed along a circumferential plane, which extends in the z-axis direction, inside the inner surfaces of the first portion 110 and the second portion 120. In other words, the receiver coil 21A is disposed so as to extend circularly when the housing 100 is viewed in the z-axis direction.

The receiver coil 21A, which is thus disposed, enables the outer shape and the central opening of the receiver coil 21A to be made large in accordance with the shape in which the first portion 110 is connected to the second portion 120.

The electronic circuit 40 is disposed approximately at the center of the interior of the housing 100.

The magnetic sheet 50A has a cylindrical shape. The magnetic sheet 50A is disposed so as to contain and cover the electronic circuit 40 (electronic circuit substrate). In other words, the magnetic sheet 50A is disposed between the receiver coil 21A and the electronic circuit 40 (electronic circuit substrate). At that time, the magnetic sheet 50A is disposed so that its cylindrical surface faces the receiver coil 21A. Preferably, in the interior of the housing 100, the cylindrical surface portion of the magnetic sheet 50A (the portion facing the receiver coil 21A) is disposed as close as possible to the receiver coil 21A.

In this configuration, the magnetic sheet 50A is disposed in the inner space of the receiver coil 21A three-dimensionally at such a position that the magnetic sheet 50A surrounds the electronic circuit 40 (electronic circuit substrate), so as to form the magnetic path of the main magnetic flux, which is linked with the receiver coil 21A, with respect to a magnetic field from the outside of the three-dimensionally structured housing 100.

### (Placement Form on the Transmitter Stand 190 and Power Reception Form)

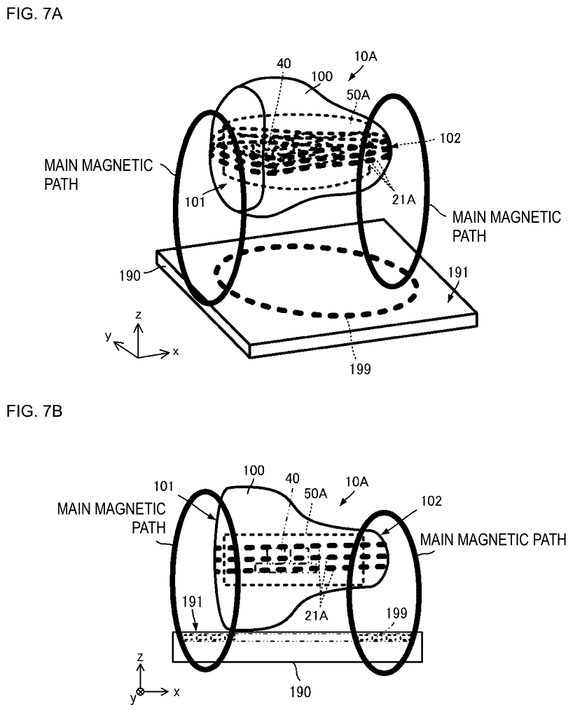

FIG. 7A is a perspective view of the case in which a wireless power receiver device is placed on or close to a transmitter stand for power transmission. FIG. 7B is a view of the state as seen in the y-axis direction.

As illustrated in FIGS. 7A and 7B, the wireless power receiver device 10A is disposed on or close to the transmitter stand 190 so that the direction, in which the first portion 110 is connected to the second portion 120, is approximately parallel to the transmitter surface 191 and that the receiver coil 21A and its round plane are parallel to the planar plane of the transmitter coil 199.

Thus, the receiver coil 21A is coupled to the magnetic flux, which is generated due to a current through the transmitter coil 199, with a high degree of coupling. Therefore, a large received current is output from the receiver coil 21A.

Further, the receiver coil 21A is formed in a large area with respect to the shape of the housing 100. Therefore, a further larger output current from the receiver coil 21A may be obtained.

According to the configuration described above, as illustrated in FIGS. 7A and 7B, the magnetic sheet 50A causes the magnetic path (main magnetic path) of the main magnetic flux to be formed at a close position on the inner side of the receiver coil 21A. This enables an increase of the flux linkage through the receiver coil 21A, achieving output of a further larger received current.

Thus, even with a small housing 100 having a three-dimensional complex structure, the wireless power receiver device 10A achieves a large received power and high efficiency of power reception.

In addition, as described above, the magnetic sheet 50A surrounds the electronic circuit 40, suppressing occurrence of the state in which the main magnetic flux is linked with the electronic circuit 40. Thus, the wireless power receiver device 10A achieves reduction of occurrence of unnecessary electromagnetic noise in the electronic circuit 40.

### Third Embodiment

A wireless power receiver device according to a third embodiment of the present disclosure will be described by referring to figures.

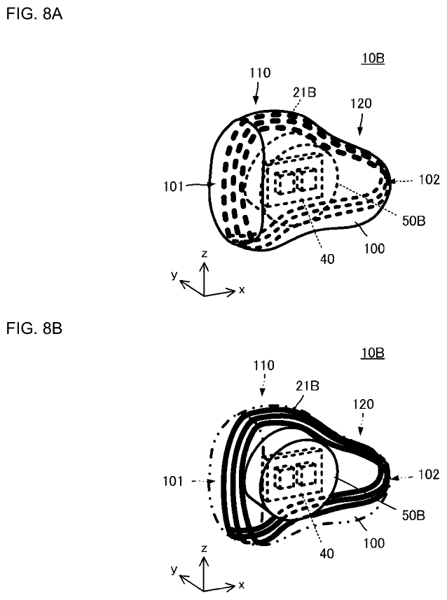

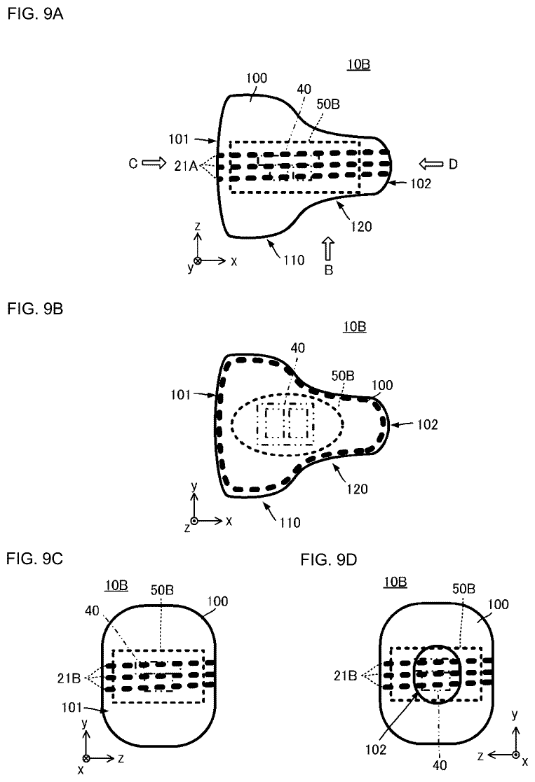

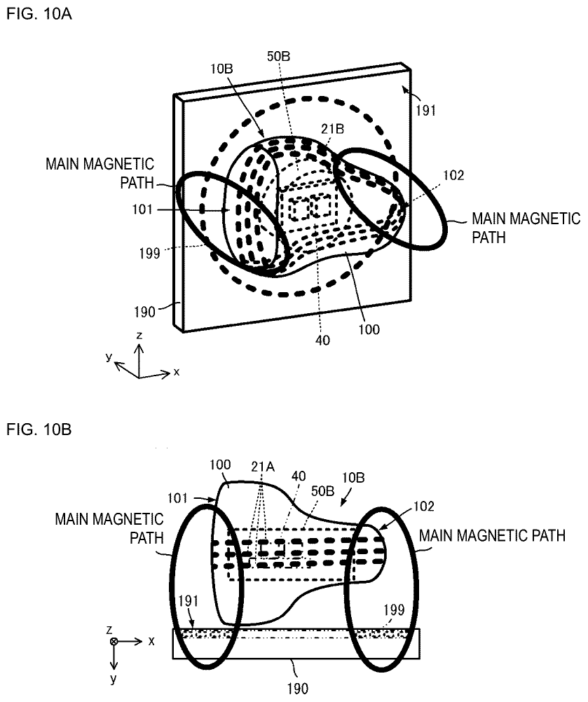

FIG. 8A is an external perspective view of a wireless power receiver device according to the third embodiment. FIG. 8B is a perspective view of the state in which the housing in FIG. 8A is seen through. FIGS. 9A, 9B, 9C, and 9D are views of the four sides of a wireless power receiver device according to the third embodiment. FIG. 9B is a view of FIG. 9A as seen in B direction; FIG. 9C is a view of FIG. 9A as seen in C direction; FIG. 9D is a view of FIG. 9A as seen in D direction.

A wireless power receiver device 10B according to the third embodiment is different from the wireless power receiver device 10 according to the first embodiment in a receiver coil 21B and a magnetic sheet 50B. The other configuration of the wireless power receiver device 10B is substantially the same as that of the wireless power receiver device 10, and substantially the same points will not be described.

The receiver coil 21B is a loop coil having a shape obtained by winding a linear conductor a predetermined number of times. The receiver coil 21B is disposed across the inner surfaces of the first portion 110 and the second portion 120 of the housing 100. Alternatively, the receiver coil 21A may be disposed on the outer surfaces of the first portion 110 and the second portion 120.

More specifically, the receiver coil 21B is disposed along a circumferential plane, which extends in the y-axis direction, inside the inner surfaces of the first portion 110 and the second portion 120. In other words, the receiver coil 21B is disposed so as to extend circularly when the housing 100 is viewed in the y-axis direction.

The receiver coil 21B, which is thus disposed, enables the outer shape and the central opening of the receiver coil 21B to be made large in accordance with the shape in which the first portion 110 is connected to the second portion 120.

The electronic circuit 40 is disposed approximately at the center of the interior of the housing 100.

The magnetic sheet 50B has a cylindrical shape. The magnetic sheet 50B is disposed so as to contain and cover the electronic circuit 40 (electronic circuit substrate). In other words, the magnetic sheet 50B is disposed between the receiver coil 21B and the electronic circuit 40 (electronic circuit substrate). At that time, the magnetic sheet 50B is disposed so that its cylindrical surface faces the receiver coil 21B. Preferably, in the interior of the housing 100, the cylindrical surface portion of the magnetic sheet 50B (the portion facing the receiver coil 21B) is disposed as close as possible to the receiver coil 21B.

In this configuration, the magnetic sheet 50B is disposed in the inner space of the receiver coil 21B three-dimensionally at such a position that the magnetic sheet 50B surrounds the electronic circuit 40 (electronic circuit substrate), so as to form the magnetic path of the main magnetic flux, which is linked with the receiver coil 21B, with respect to a magnetic field from the outside of the three-dimensionally structured housing 100.

### (Placement Form on the Transmitter Stand 190 and Power Reception Form)

FIG. 10A is a perspective view of the case in which a wireless power receiver device is placed on or close to a transmitter stand for power transmission. FIG. 10B is a view of the state as seen in the z-axis direction.

As illustrated in FIGS. 10A and 10B, the wireless power receiver device 10B is disposed on or close to the transmitter stand 190 so that the direction, in which the first portion 110 is connected to the second portion 120, is approximately parallel to the transmitter surface 191 and that the receiver coil 21B and its round plane are parallel to the planar plane of the transmitter coil 199.

Thus, the receiver coil 21B is coupled to the magnetic flux, which is generated due to a current through the transmitter coil 199, with a high degree of coupling. Therefore, a large received current is output from the receiver coil 21B.

Further, the receiver coil 21B is formed in a large area with respect to the shape of the housing 100. Therefore, a further larger output current from the receiver coil 21B may be obtained.

According to the configuration described above, as illustrated in FIGS. 10A and 10B, the magnetic sheet 50B causes the magnetic path (main magnetic path) of the main magnetic flux to be formed at a close position on the inner side of the receiver coil 21B. This enables an increase of the flux linkage through the receiver coil 21B, achieving output of a further larger received current.

Thus, even with a small housing 100 having a three-dimensional complex structure, the wireless power receiver device 10B achieves a large received power and high efficiency of power reception.

In addition, as described above, the magnetic sheet 50B surrounds the electronic circuit 40, suppressing occurrence of the state in which the main magnetic flux is linked with the electronic circuit 40. Thus, the wireless power receiver device 10B achieves reduction of occurrence of unnecessary electromagnetic noise in the electronic circuit 40.

In the embodiments described above, a hearing aid is taken as an example. However, the shape of the housing of a wireless power receiver device is not limited to this. The configuration described above may be effectively applied to a shape which is different from a simple three-dimensional shape and in which multiple three-dimensional shapes are combined. In addition, the effects described above may be exerted.

In addition, in the embodiments described above, the form in which the magnetic sheet has a cylindrical shape is described. However, the magnetic sheet may be, for example, a rectangular parallelepiped shape, a cubic shape, or an elliptical cylinder shape in accordance with the winding shape of the receiver coil 21.

<1> A wireless power receiver device comprising a receiver loop coil that is used in wireless power transmission; an electronic circuit substrate that includes a power receiving circuit which is electrically connected to the receiver loop coil; a load circuit that performs an electrical operation by using received power obtained from the power receiving circuit; a magnetic sheet that is disposed with respect to the receiver loop coil; and a housing that includes the receiver loop coil, the electronic circuit substrate, the load circuit, and the magnetic sheet which are disposed therein and that has a three-dimensional complex structure. The electronic circuit substrate and the load circuit include electronic components. The receiver loop coil has a shape having a plurality of curvatures and bending three-dimensionally along an outer surface or an inner surface of the three-dimensionally structured housing. The magnetic sheet is disposed in an inner space of the receiver loop coil three-dimensionally at such a position that the magnetic sheet surrounds the electronic circuit substrate and the load circuit, so as to form a magnetic path of a main magnetic flux with respect to a magnetic field from an outside of the three-dimensionally structured housing, the main magnetic flux being linked with the receiver loop coil. Also, for the receiver loop coil, flux linkage is increased to obtain a larger received power at the power receiving circuit, and, for the electronic circuit substrate and the load circuit, linkage of the main magnetic flux is suppressed to reduce occurrence of unnecessary electromagnetic noise in the electronic circuit substrate and the load circuit.

<2> The wireless power receiver device according to <1>, wherein the power receiving circuit includes a receiver resonant circuit constituted by the receiver loop coil and a resonant capacitor, and the receiver resonant circuit is used to flow a resonant current through the receiver loop coil, and the magnetic path of the main magnetic flux linked with the receiver loop coil is formed.

<3> The wireless power receiver device according to <1> or <2>, wherein the magnetic sheet is disposed in a cylindrical shape.

<4> The wireless power receiver device according to <1> or <2>, wherein the magnetic sheet is disposed in a rectangular parallelepiped shape.

<5> The wireless power receiver device according to any one of <1> to <4>, wherein the receiver loop coil is included in a first flexible circuit substrate.

<6> The wireless power receiver device according to any one of <1> to <5>, wherein the electronic circuit substrate is constituted by a second flexible circuit substrate of a multilayer body having a resin layer and a conductor layer.

<7> The wireless power receiver device according to any one of <1> to <6>, wherein the electronic circuit substrate includes a first area in which the receiver loop coil is formed, and a second area in which the electronic components are mounted. The number of laminated layers of a resin layer and a conductor layer in the first area is greater than the number of laminated layers of a resin layer and a conductor layer in the second area, and the conductor layer in the first area is electrically connected to the conductor layer in the second area.

<8> The wireless power receiver device according to any one of <1> to <7>, comprising a power storage device that stores the received power, wherein the power storage device is electrically connected to a given electronic circuit of the load circuit.

<9> The wireless power receiver device according to any one of <1> to <8>, wherein the load circuit includes a wireless communication circuit that performs wireless communication using a frequency identical to an operating frequency of power reception.

<10> The wireless power receiver device according to any one of <1> to <8>, wherein the load circuit includes a wireless communication circuit that performs wireless communication using a frequency different from an operating frequency of power reception.

<11> The wireless power receiver device according to any one of <1> to <10>, wherein the three-dimensionally structured housing forms at least a part of a hearing aid.

What is claimed is:

1. A wireless power receiver device comprising:
a receiver loop coil configured for use in wireless power transmission;
an electronic circuit substrate that includes a power receiving circuit which is electrically connected to the receiver loop coil;
a load circuit configured to perform an electrical operation by using received power obtained from the power receiving circuit;
a magnetic sheet that is in an inner space of the receiver loop coil; and
a housing that houses the receiver loop coil, the electronic circuit substrate, the load circuit, and the magnetic sheet and that has a three-dimensional complex structure,
wherein
the electronic circuit substrate and the load circuit include electronic components,
the receiver loop coil has a shape having a plurality of curvatures and bending three-dimensionally along an outer surface or an inner surface of the three-dimensionally structured housing,
the magnetic sheet is in the inner space of the receiver loop coil three-dimensionally at such a position that the magnetic sheet surrounds the electronic circuit substrate and the load circuit, to define a magnetic path of a main magnetic flux with respect to a magnetic field from an outside of the three-dimensionally structured housing, the main magnetic flux being linked with the receiver loop coil, and
for the receiver loop coil, flux linkage is increased to obtain a larger received power at the power receiving circuit, and, for the electronic circuit substrate and the load circuit, linkage of the main magnetic flux is suppressed to reduce occurrence of unnecessary electromagnetic noise in the electronic circuit substrate and the load circuit.

2. The wireless power receiver device according to claim 1, wherein
the power receiving circuit includes a receiver resonant circuit configured by the receiver loop coil and a resonant capacitor, and
the receiver resonant circuit is configured to flow a resonant current through the receiver loop coil to create the magnetic path of the main magnetic flux linked with the receiver loop coil.

3. The wireless power receiver device according to claim 1, wherein
the magnetic sheet is configured in a cylindrical shape.

4. The wireless power receiver device according to claim 1, wherein
the magnetic sheet is configured in a rectangular parallelepiped shape.

5. The wireless power receiver device according to claim 1, wherein
the receiver loop coil is in a first flexible circuit substrate.

6. The wireless power receiver device according to claim 1, wherein
the electronic circuit substrate is configured by a second flexible circuit substrate of a multilayer body having a resin layer and a conductor layer.

7. The wireless power receiver device according to claim 1, wherein
the electronic circuit substrate includes
a first area in which the receiver loop coil is configured, and
a second area in which the electronic components are mounted,
a number of laminated layers of a resin layer and a conductor layer in the first area is greater than a number of laminated layers of a resin layer and a conductor layer in the second area, and
the conductor layer in the first area is electrically connected to the conductor layer in the second area.

8. The wireless power receiver device according to claim 1, further comprising:
a power storage device that is configured to store the received power,
wherein the power storage device is electrically connected to a given electronic circuit of the load circuit.

9. The wireless power receiver device according to claim 1, wherein
the load circuit includes
a wireless communication circuit that is configured to perform wireless communication using a frequency identical to an operating frequency of power reception.

10. The wireless power receiver device according to claim 1, wherein the load circuit includes
a wireless communication circuit that is configured to perform wireless communication using a frequency different from an operating frequency of power reception.

11. The wireless power receiver device according to claim 1, wherein
the three-dimensionally structured housing configured at least a part of a hearing aid.

12. The wireless power receiver device according to claim 2, wherein
the magnetic sheet is configured in a cylindrical shape.

13. The wireless power receiver device according to claim 2, wherein
the magnetic sheet is configured in a rectangular parallelepiped shape.

14. The wireless power receiver device according to claim 2, wherein
the receiver loop coil is in a first flexible circuit substrate.

15. The wireless power receiver device according to claim 2, wherein
the electronic circuit substrate is configured by a second flexible circuit substrate of a multilayer body having a resin layer and a conductor layer.

16. The wireless power receiver device according to claim 2, wherein
the electronic circuit substrate includes
a first area in which the receiver loop coil is configured, and
a second area in which the electronic components are mounted,
a number of laminated layers of a resin layer and a conductor layer in the first area is greater than a number of laminated layers of a resin layer and a conductor layer in the second area, and
the conductor layer in the first area is electrically connected to the conductor layer in the second area.

17. The wireless power receiver device according to claim 2, further comprising:
a power storage device that is configured to store the received power,
wherein the power storage device is electrically connected to a given electronic circuit of the load circuit.

18. The wireless power receiver device according to claim 2, wherein
the load circuit includes
a wireless communication circuit that is configured to perform wireless communication using a frequency identical to an operating frequency of power reception.

19. The wireless power receiver device according to claim 2, wherein the load circuit includes
a wireless communication circuit that is configured to perform wireless communication using a frequency different from an operating frequency of power reception.

20. The wireless power receiver device according to claim 2, wherein
the three-dimensionally structured housing configured at least a part of a hearing aid.
